(19) United States
(12) Patent Application Publication
(10) Pub. No.: US 2024/0336136 A1
(43) Pub. Date: Oct. 10, 2024

(54) SWITCH DEVICE

(71) Applicant: KABUSHIKI KAISHA TOKAI RIKA DENKI SEISAKUSHO, Aichi (JP)

(72) Inventors: Yosuke HATADA, Aichi (JP); Yuta YAMANISHI, Aichi (JP); Masahiro KATO, Aichi (JP); Sota SUZUKI, Aichi (JP)

(73) Assignee: KABUSHIKI KAISHA TOKAI RIKA DENKI SEISAKUSHO, Aichi (JP)

(21) Appl. No.: 18/626,648

(22) Filed: Apr. 4, 2024

(30) Foreign Application Priority Data
Apr. 10, 2023 (JP) 2023-063546

(51) Int. Cl. B60K 35/10; B62D 1/12; B62D 1/22

(52) U.S. Cl. CPC B60K 35/10; B62D 1/12; B62D 1/22

(57) ABSTRACT

A support is adapted to be coupled to a steering shaft configured to change a traveling direction of a vehicle. A switch is coupled to the support and configured to output a signal in accordance with an operation of a driver of the vehicle. A processing unit includes a connector configured to accept connection of a cable for transmitting the signal, and a processor configured to process the signal. At least one snap-fit structure configured to allow attachment and detachment of the processing unit from below the support under a condition that the switch is still coupled to the support. The connector faces downward under a condition that the processing unit is attached to the support.

### CROSS-REFERENCE TO RELATED APPLICATION

The present application is based on Japanese Patent Application No. 2023-063546 filed on Apr. 10, 2023, the entire contents of which are incorporated herein by reference.

### BACKGROUND

The presently disclosed subject matter relates to a switch device adapted to be installed in a vehicle.

Japanese Patent Publication No. 2004-231016A discloses a switch device adapted to be installed in a vehicle. The switch device includes a support and a lever switch. The support is coupled to a steering shaft for changing the traveling direction of the vehicle. The lever switch is coupled to the support via a connector without cables, and outputs a signal according to an operation of a user. The support includes a processor for processing the signal. When replacing the processor, it is necessary to decouple the support and the lever switch.

### SUMMARY

It is demanded to enhance workability for replacing a processor having a function of processing a signal in a switch device adapted to be installed in a vehicle.

An illustrative aspect of the presently disclosed subject matter provides a switch device, comprising:
a support adapted to be coupled to a steering shaft configured to change a traveling direction of a vehicle;
a switch coupled to the support and configured to output a signal in accordance with an operation of a driver of the vehicle;
a processing unit including a connector configured to accept connection of a cable for transmitting the signal, and a processor configured to process the signal; and
at least one snap-fit structure configured to allow attachment and detachment of the processing unit from below the support under a condition that the switch is still coupled to the support,
wherein the connector faces downward under a condition that the processing unit is attached to the support.

According to the configuration as described above, the attaching/detaching operation with respect to the support and the attaching/detaching operation of the cable with respect to the connector of the processing unit both of which are performed when replacing the processing unit can be performed from below the switch device. The attachment and detachment of the processing unit with respect the support are performed through the use of the simple snap-fit structure without requiring the decoupling of the switch and the support. In addition, the connector faces downward. Accordingly, these operations can be performed with blind manipulations, so that the operator does not have to place his/her upper body in a narrow space below the steering column module. Accordingly, it is possible to enhance the replacement workability of a processor having a function of processing a signal in the switch device.

### DESCRIPTION OF THE DRAWINGS

FIG. 1 illustrates an appearance of a switch device according to one exemplary embodiment.

FIG. 2 illustrates a state where a switch and a processing unit are detached from a support of the switch device of FIG. 1.

FIG. 3 illustrates a state where the processing unit are detached from the support of the switch device of FIG. 1.

FIG. 4 illustrates an appearance of the processing unit attached to the support of the switch device of FIG. 1 as viewed from below.

### DESCRIPTION OF EMBODIMENTS

Exemplary embodiments will be described in detail below with reference to the accompanying drawings. In the accompanying drawings, an arrow F represents a forward direction of an illustrated structure. An arrow B represents a rearward direction of an illustrated structure. An arrow U represents an upward direction of an illustrated structure. An arrow D represents a downward direction of an illustrated structure. An arrow R represents a rightward direction of an illustrated structure. An arrow L represents a leftward direction of an illustrated structure.

As used herein, the term “front-rear direction” means a direction along the forward direction and the rearward direction described above. As used herein, the term “up-down direction” means a direction along the upward direction and the downward direction described above. As used herein, the term “left-right direction” means a direction along the leftward direction and the rightward direction described above.

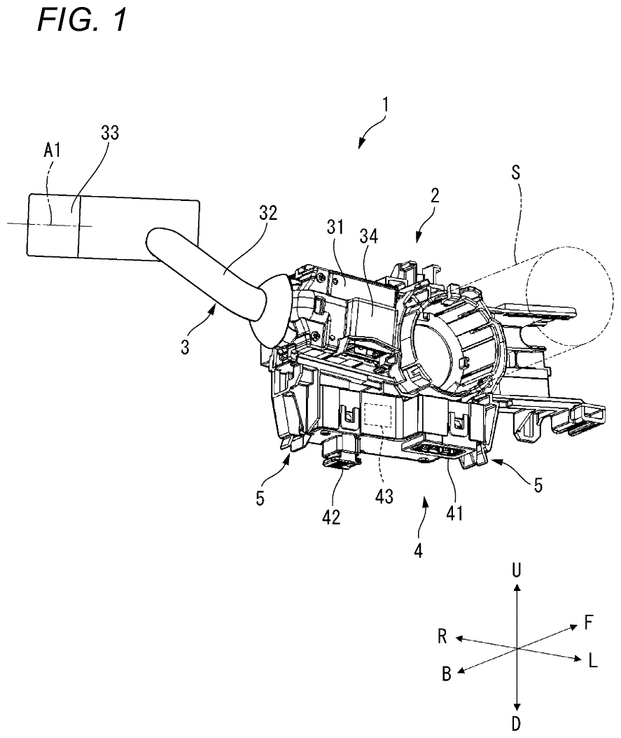

FIG. 1 illustrates an appearance of a switch device 1 according to one exemplary embodiment when viewed from a lower right front side. The switch device 1 is adapted to be installed in a vehicle. The forward direction, the rearward direction, the leftward direction, and the rightward direction described above respectively correspond to the forward direction, the rearward direction, the leftward direction, and the rightward direction seen from a driver in the vehicle.

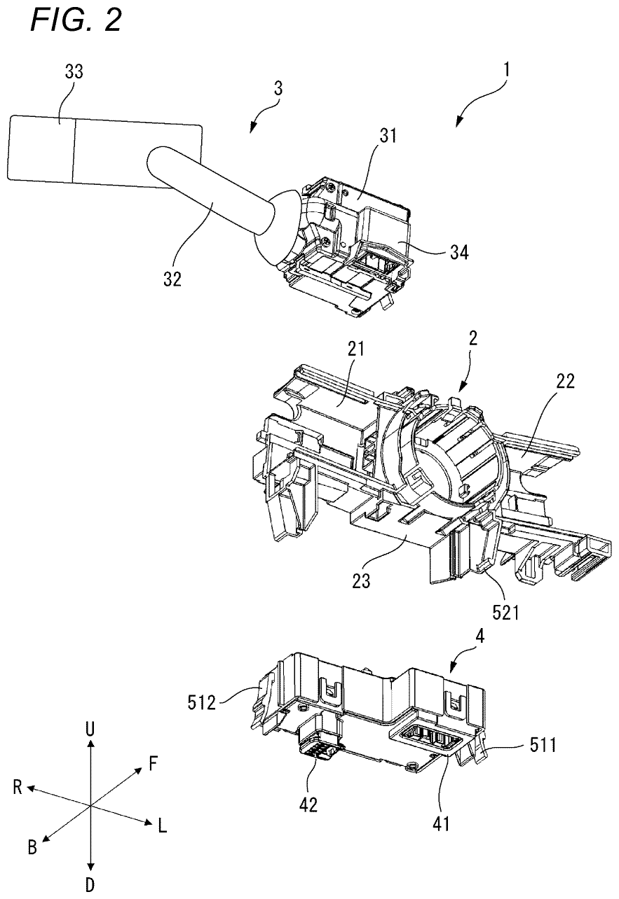

The switch device 1 includes a support 2, a switch 3, and a processing unit 4. The switch 3 and the processing unit 4 are configured to be detachable from the support 2. FIG. 2 illustrates a state where the switch 3 and the processing unit 4 are detached from the support 2.

The switch device 1 constitutes a part of a steering column module adapted to be installed in the vehicle. As illustrated in FIG. 1, the support 2 is configured to be coupled to a steering shaft S for changing the traveling direction of the vehicle.

As illustrated in FIG. 2, the support 2 includes a right receptacle 21. The switch 3 includes a base 31. When the base 31 is fitted into the right receptacle 21, the switch 3 is coupled to the support 2.

As illustrated in FIG. 1, the switch 3 includes a lever switch 32. The lever switch 32 is movable in the up-down direction. The lever switch 32 accepts an operation involving the movement in order to turn on a direction indicator of the vehicle, for example. The lever switch 32 is configured to output a signal corresponding to the operation.

The switch 3 includes a knob switch 33. The knob switch 33 is rotatable about a rotation axis A1. The knob switch 33 accepts an operation involving the rotation in order to change a lighting state of a headlight of the vehicle, for example. The knob switch 33 is configured to output a signal corresponding to the operation.

The switch 3 includes a connector 34. The connector 34 is configured to accept connection of one end of a cable for transmitting a signal outputted from the switch 3. The connector 34 faces downward.

The processing unit 4 includes a first connector 41. The first connector 41 is configured to accept connection of the other end of the cable. In other words, the signal outputted from the switch 3 in accordance with the operation of the driver is inputted to the processing unit 4 via the first connector 41.

The processing unit 4 includes a second connector 42 and a processor 43. The processor 43 is electrically connected to the first connector 41 and the second connector 42. The processor 43 is configured to receive the signal outputted from the switch 3 through the first connector 41, and to output, from the second connector 42, a control signal for controlling an operation of a controlled device associated with the switch 3 based on the signal.

The processor 43 having such a function can be implemented by an integrated circuit element such as a microcontroller, an ASIC, and an FPGA.

The second connector 42 is configured to accept connection of an end of a cable for transmitting the control signal generated by the processor 43 to the controlled device associated with the switch 3 or a control device for controlling the operation of the controlled device.

As illustrated in FIG. 2, the support 2 includes a left receptacle 22. Another switch (not illustrated) may be coupled as required. The other switch is associated with an operation control of a controlled device that is different from one controlled by each of the lever switch 32 and the knob switch 33.

The support 2 includes a lower receptacle 23. The lower receptacle 23 allows the processing unit 4 to be detached downward.

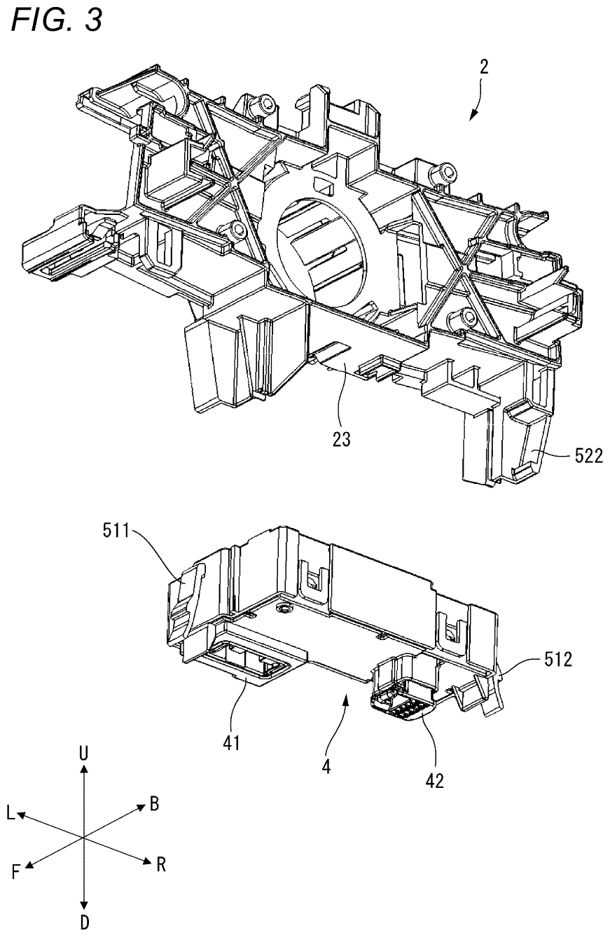

FIG. 3 illustrates an appearance of a state where the processing unit 4 is detached from the support 2 as seen from a lower left rear side.

As illustrated in FIG. 1, the switch device 1 includes a snap-fit structure 5. The snap-fit structure 5 is configured to allow attachment and detachment of the processing unit 4 from below the support 2 under the condition that the switch 3 is still coupled to the support 2.

Specifically, as illustrated in FIGS. 2 and 3, the snap-fit structure 5 includes a first engaging member 511, a second engaging member 512, a first engaged member 521, and a second engaged member 522. The first engaging member 511 is provided on a left side wall of the processing unit 4. The second engaging member 512 is provided on a right side wall of the processing unit 4. The first engaged member 521 is provided in a portion of the lower receptacle 23 that can face the left side wall of the processing unit 4. The second engaged member 522 is provided in a portion of the lower receptacle 23 that can face the right side wall of the processing unit 4.

The first engaging member 511 and the second engaging member 512 have higher flexibility than the first engaged member 521 and the second engaged member 522. When the processing unit 4 is disposed from below in the lower receptacle 23 of the support 2, the first engaging member 511 and the second engaging member 512 are snap-fitted with the first engaged member 521 and the second engaged member 522 while being bent. As a result, the processing unit 4 is coupled to the support 2.

In order to cancel the coupling between the support 2 and the processing unit 4, the first engaging member 511 and the second engaging member 512 are forcibly bent. As a result, the snap-fit engagement is canceled, so that the processing unit 4 can be removed downward.

As illustrated in FIG. 1, under a condition that the processing unit 4 is attached to the support 2, the first connector 41 and the second connector 42 face downward. Accordingly, the operation of attaching and detaching the above-described cables with respect to these connectors can also be performed from below the switch device 1.

According to the configuration of the present exemplary embodiment, the attaching/detaching operation with respect to the support 2 and the attaching/detaching operation of the cables with respect to the first connector 41 and the second connector 42 of the processing unit 4 both of which are performed when replacing the processing unit 4 can be performed from below the switch device 1. The attachment and detachment of the processing unit 4 with respect the support 2 are performed through the use of the simple snap-fit structure 5 without requiring the decoupling of the switch 3 and the support 2. In addition, the first connector 41 and the second connector 42 face downward. Accordingly, these operations can be performed with blind manipulations, so that the operator does not have to place his/her upper body in a narrow space below the steering column module. Accordingly, it is possible to enhance the replacement workability of the processor 43 having a function of processing a signal in the switch device 1.

It should be noted that, since the other end of the cable connected to the first connector 41 of the processing unit 4 is connected to the connector 34 of the switch 3 facing downward, it is also possible to perform the work with blind manipulations. As a result, it is possible to secure flexibility as for the arrangement of the first connector 41 with respect to the connector 34 while suppressing decrease of the wiring workability.

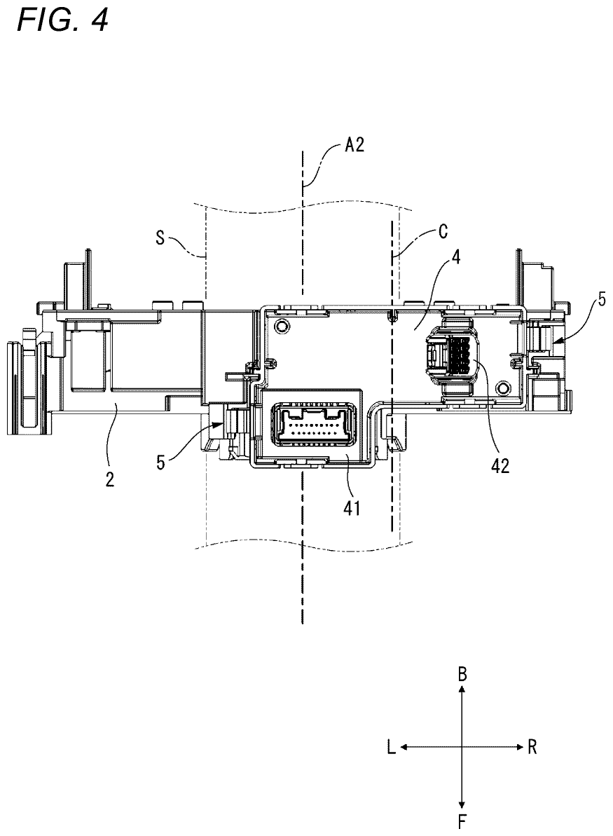

In addition, since the configurations related to the replacement of the processor 43 are gathered below the support 2 coupled to the steering shaft S, it is easy to secure a space for installing another interior device above the steering shaft S. As a result, it is possible to improve the flexibility as for the layout of the interior device in a vehicle cabin. FIG. 4 illustrates a state where the processing unit 4 is coupled to the support 2 as

viewed from below. A center position C in the width direction of the processing unit 4 corresponding to the left-right direction of the vehicle is located on the right of the rotation axis A2 of the steering shaft S. In other words, the center position C is located closer to a door adjacent to a driver's seat of the vehicle than the rotation axis A2.

According to such a configuration, it is possible to enhance the accessibility to the first connector 41, the second connector 42, and the snap-fit structure 5 from outside the vehicle cabin under a condition that the door adjacent to the driver's seat is opened. Since the worker can perform the replacement work of the processing unit 4 with blind manipulations without entering the vehicle cabin, it is possible to further enhance the workability.

Each configuration described above is merely illustrative for facilitating understanding of the presently disclosed subject matter. Each of the above exemplary configurations can be appropriately modified or combined with another exemplary configuration within the teaching of the presently disclosed subject matter.

In the snap-fit structure 5 according to the above exemplary embodiment, an engaging member having a relatively high flexibility is provided on the processing unit 4, whereas an engaged member is provided on the support 2. However, the support 2 may be provided with an engaging member, and the processing unit 4 may be provided with an engaged member.

The snap-fit structure 5 according to the above exemplary embodiment includes a pair of engaging members and a pair of engaged members. However, the snap-fit structure 5 may include at least one pair of an engaging member and an engaged member. In the case of the example illustrated in FIG. 4, the pair of the first engaging member 511 and the first engaged member 521 may be replaced with a simple hook-engagement structure. In this case, the second engaging member 512 and the second engaged member 522 can be snap-fitted by lifting a right portion of the processing unit 4 under a condition that a left portion of the processing unit 4 is hung on a mating portion of the lower receptacle 23.

In other words, it is preferable to dispose the single snap-fit structure 5 on the right of the rotation axis A2 of the steering shaft S. In other words, the single snap-fit structure 5 is preferably disposed closer to the door adjacent to the driver's seat of the vehicle than the rotation axis A2 of the steering shaft S.

According to such a configuration, it is possible to enhance the accessibility to the snap-fit structure 5 from the outside of the vehicle cabin under a condition that the door adjacent to the driver's seat is opened. Since the worker can perform the operation of the snap-fit structure 5 with blind manipulations without entering the vehicle cabin, it is possible to further enhance the workability.

1. A switch device, comprising:
a support adapted to be coupled to a steering shaft configured to change a traveling direction of a vehicle;
a switch coupled to the support and configured to output a signal in accordance with an operation of a driver of the vehicle;
a processing unit including a connector configured to accept connection of a cable for transmitting the signal, and a processor configured to process the signal; and
at least one snap-fit structure configured to allow attachment and detachment of the processing unit from below the support under a condition that the switch is still coupled to the support,
wherein the connector faces downward under a condition that the processing unit is attached to the support.

2. The switch device according to claim 1,
wherein a center position of the processing unit in a width direction that corresponds to a left-right direction of the vehicle is located closer to a door adjacent to a driver's seat of the vehicle than a rotation axis of the steering shaft, under the condition that the processing unit is attached to the support.

3. The switch device according to claim 1,
wherein the at least one snap-fit structure is located closer to a door adjacent to a driver's seat of the vehicle than a rotation axis of the steering shaft.
